(19) United States
(12) Patent Application Publication
(10) Pub. No.: US 2004/0120518 A1
(43) Pub. Date: Jun. 24, 2004

(54) Matrix multiplication for cryptographic processing

(76) Inventors: William W. Macy, Palo Alto, CA (US); Eric Debes, Santa Clara, CA (US)

Correspondence Address: Robert A. Burtzlaff, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/327,449

(22) Filed: Dec. 20, 2002

(51) Int. Cl. H04K 1/00

(52) U.S. Cl. 380/29

(57) ABSTRACT

An example of encryption method for matrix intensive block ciphers is described. The matrix multiplication requires loading each diagonal of the multiplicand matrix into a different register of a processor, and loading a multiplier matrix into at least one register in column order. Matrix operations are efficient for small 4×4 matrices commonly used in Rijndael or Twofish encryption systems.

### FIELD OF THE INVENTION

The present invention relates to cryptographic processing. More particularly, the present invention provides examples of efficient Rijndael matrix multiplications.

### BACKGROUND

Encryption and decryption of digital information is a common task of general purpose processors. One encryption procedure commonly referred to as a “block cipher” uses a symmetric-key encryption algorithm to transform a fixed-length block of plaintext data into a block of ciphertext data of the same length using a secret key provided by a user. Decryption is performed by applying the reverse transformation to the ciphertext block using the same secret key. Since different plaintext blocks are mapped to different ciphettext blocks (to allow unique decryption), a block cipher effectively provides a permutation (one to one reversible correspondence) of the set of all possible messages. The permutation during any particular encryption is secret, being a function of the secret key. In general, most block ciphers consist of a single round type that is applied to a data block multiple times, with a different subkey applied in each round. By repeating this process several times, the data is obscured by the key.

A national standard block cipher known as the Advanced Encryption Standard (AES) has been adopted by the National Institute of Standard and Technology (NIST). The AES (based on the Rijndael algorithm) is a block cipher that operates on 128-bit data blocks with either a 128, 192, or 256-bit key. The Rijndael encryption algorithm consists of a single round repeated 10, 12, or 14 times to encrypt a data block, and is based on 8-bit operations including substitutions, matrix transformations, and XORs. Since the Rijndael encryption algorithm includes matrix transformations, suitable matrix processing speed improvements by appropriate use of registers can result in improvement of overall encryption speed.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 schematically illustrates a computing system supporting SIMD registers;

FIG. 2 presents one embodiment of an procedure for block cipher encryption/decryption using a Rijndael algorithm;

FIG. 3 is a procedure for reordering data for efficient matrix multiplication;

FIG. 4 illustrates a Rijndael 4×4 modular matrix multiplication;

FIG. 5 illustrates reordering of data for register based multiplication;

FIG. 6 illustrates the registers after reordering according to FIG. 5; and

FIG. 7 illustrates matrix multiplication after reordering according to FIGS. 5 and 6.

### DETAILED DESCRIPTION

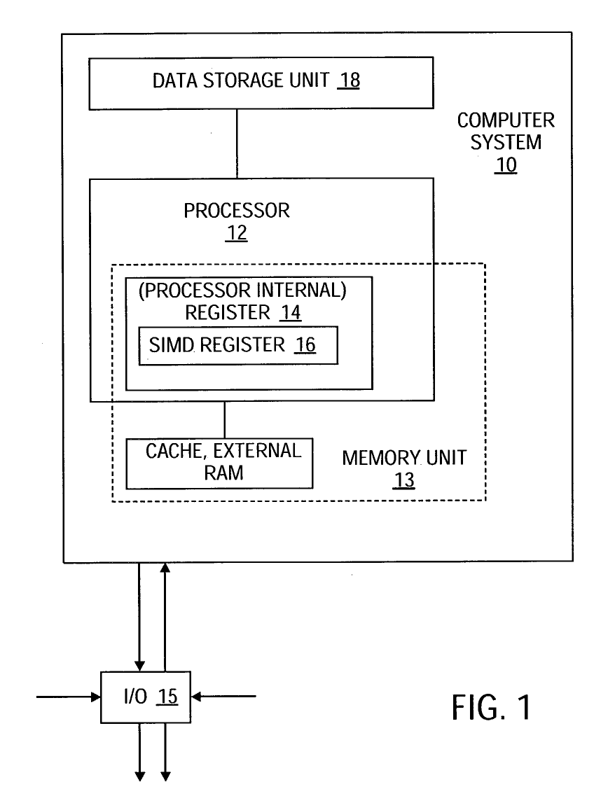

FIG. 1 generally illustrates a computing system 10 having a processor 12 and memory system 13 (which can be external cache memory, external RAM, and/or memory partially internal to the processor) for executing instructions that can be externally provided in software as a computer program product and stored in data storage unit 18.

The processor 12 of computing system 10 also supports internal memory registers 14, including Single Instruction, Multiple Data (SIMD) registers 16. Registers 14 are not limited in meaning to a particular type of memory circuit. Rather, a register of an embodiment requires the capability of storing and providing data, and performing the functions described herein. In one embodiment, the register 14 includes multimedia registers, for example, SIMD registers 16 for storing multimedia information. In one embodiment, multimedia registers each store up to one hundred twenty-eight bits of packed data. Multimedia registers may be dedicated multimedia registers or registers which are used for storing multimedia information and other information. In one embodiment, multimedia registers store multimedia data when performing multimedia operations and store floating point data when performing floating point operations.

The computer system 10 of the present invention may include one or more I/O (input/output) devices 15, including a display device such as a monitor. The I/O devices may also include an input device such as a keyboard, and a cursor control such as a mouse, trackball, or trackpad. In addition, the I/O devices may also include a network connector such that computer system 10 is part of a local area network (LAN) or a wide area network (WAN), the I/O devices 15, a device for sound recording, and/or playback, such as an audio digitizer coupled to a microphone for recording voice input for speech recognition. The I/O devices 15 may also include a video digitizing device that can be used to capture video images, a hard copy device such as a printer, and a CD-ROM device.

In one embodiment, a computer program product readable by the data storage unit 18 may include a machine or computer-readable medium having stored thereon instructions which may be used to program (i.e. define operation of) a computer (or other electronic devices) to perform a process according to the present invention. The computer-readable medium of data storage unit 18 may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

Accordingly, the computer-readable medium includes any type of media/machine-readable medium suitable for storing electronic instructions. Moreover, the present invention may also be downloaded as a computer program product. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

Computing system 10 can be a general-purpose computer having a processor with a suitable register structure, or can be configured for special purpose or embedded applications. In an embodiment, the methods of the present invention are embodied in machine-executable instructions directed to control operation of the computing system, and more specifically, operation of the processor and registers. The instructions can be used to cause a general-purpose or special-purpose processor that is programmed with the instructions to perform the steps of the present invention. Alternatively, the steps of the present invention might be performed by specific hardware components that contain hardwired logic for performing the steps, or by any combination of programmed computer components and custom hardware components.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression.

Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

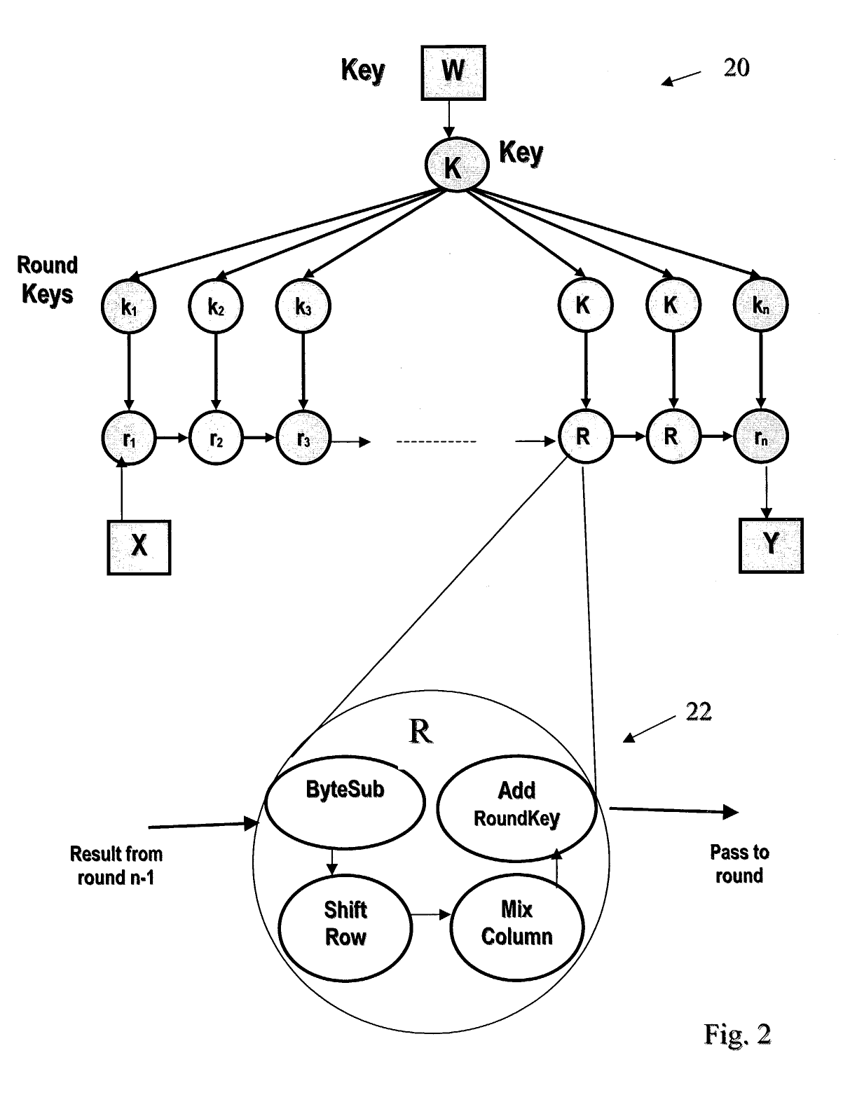

FIG. 2 presents one embodiment of an procedure 20 for block cipher encryption/decryption using a Rijndael algorithm. As seen in FIG. 2, a key is expanded to a set of n round keys. Input block X undergoes n rounds of operations (each operation is based on value of the nth round key), until it reaches a final round and output block Y As seen in the magnified view of round 22 each byte at the input of a round undergoes a non-linear byte substitution (ByteSub) according to a non-linear transform. This ensures that there is no linear relationship between the input and output of a round. A ShiftRow operation cyclically shifts each “row” of the block according to a predetermined table, guaranteeing high diffusion over multiple rounds. In the MixColumn operation each column is multiplied by a polynomial to reduce correlation between bytes of the round input and the bytes of the output. The MixColumn operation is applied to each round of Rijndael encryption, excepting the final round in which the MixColumn operation is omitted (the other standard round operations are performed).

The final step of each round is key addition layer where of the input are XOR'ed with the expanded round key. As will be appreciated, the strength of algorithm relies on the difficulty of obtaining the intermediate result (or state) of round n from round n+1 without the round key. Since the key is symmetrical, a reversal of the foregoing procedure using the same key as applied during encryption will result in decryption into plaintext of an encrypted block.

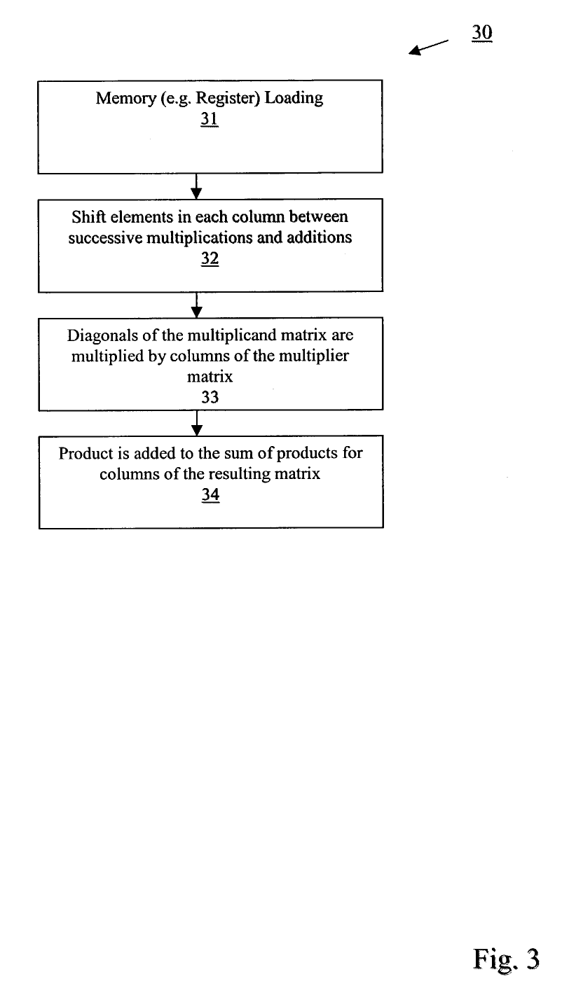

In one embodiment illustrated with respect to FIG. 3, the 4×4 matrix multiplication procedure 30 required in a Rijndael encryption/decryption procedure for MixColumn operation in each round can be efficiently computed using appropriate data reordering, register loads and calculations. Data is first organized by reordering and loading in memory (e.g. the memory registers of box 31) for efficient matrix multiplication. As will be understood, it is not always necessary to load an internal processor register to perform the SIMD operation. Operands used for multiplication, and other operands used for other operations such as shuffle patterns for shuffle instructions, are stored in memory instead of loaded into a register first. Certain architectures such as RISC architectures load registers first, but the Intel Architecture can have operands that are in memory. A comparison of use of register and memory operands is

pmaddwd xmm0, xmm1 and

pmaddwd xmm0, [eax]

These produce the same result in xmm0 if data stored in address that is in register eax is the same as data in xmm1. It is desirable to use the memory operand if the code runs out of registers and the memory access is fast. In the following examples, encryption code includes loading two diagonals into registers, while the other 2 diagonals are all ones so it is not necessary to load them. However, no diagonals for row shift for decryption are all ones. In this case it might be more desirable to use memory operands for diagonal data if the code runs out of registers to hold diagonals and there is fast cache memory access for the diagonals. In certain embodiments, (Is this the beginning of the sentence that begins with Each diagonal?)

Each diagonal of the multiplicand matrix, c, is loaded into a different register. Those diagonals with an element in the right most column that is not in the bottom row is extended to the element in the next row using a copy of the matrix positioned adjacent to the right column. The next element of a diagonal is in the next row. The diagonals are duplicated in register(s) a number of times equal to the number of columns in the multiplier matrix, a. The number of elements in a diagonal is equal to the number of columns in c. Data of the multiplier matrix, a, is loaded into registers(s) in column order, the order data is stored in memory. Between each multiplication and addition elements in each column of a in the register are shifted one element (box 32). The last element of a column is shifted or rotated to the front of the column. Diagonals of the multiplicand c matrix are multiplied by columns of the multiplier a matrix (that may have been adjusted in length) (box 23) and their product is added to the sum of products for columns of the result matrix, b (box 34).

If the number of elements of a column of a is different from the number of a column of c, the number of elements from a column of a in the SIMD register is adjusted to equal the number of elements in a column of c. One way of determining which elements of multiplier matrix a to select is first stack copies of multiplier matrix a on top of each other so columns are aligned and so that the top row of a copy is below the bottom row and other copy. This effectively extends each column. Since the number of elements taken from an extended column is equal to the number of elements in a diagonal of the multiplicand matrix c. Following each multiply and add operation elements are selected for the next multiply and add operation by shifting the down the extended column an element. If the length of a multiplicand diagonal is greater than a multiplier column then equal values will be selected from a column, and if the length of a multiplicand diagonal is less than a multiplier column then not all values from a column will be selected.

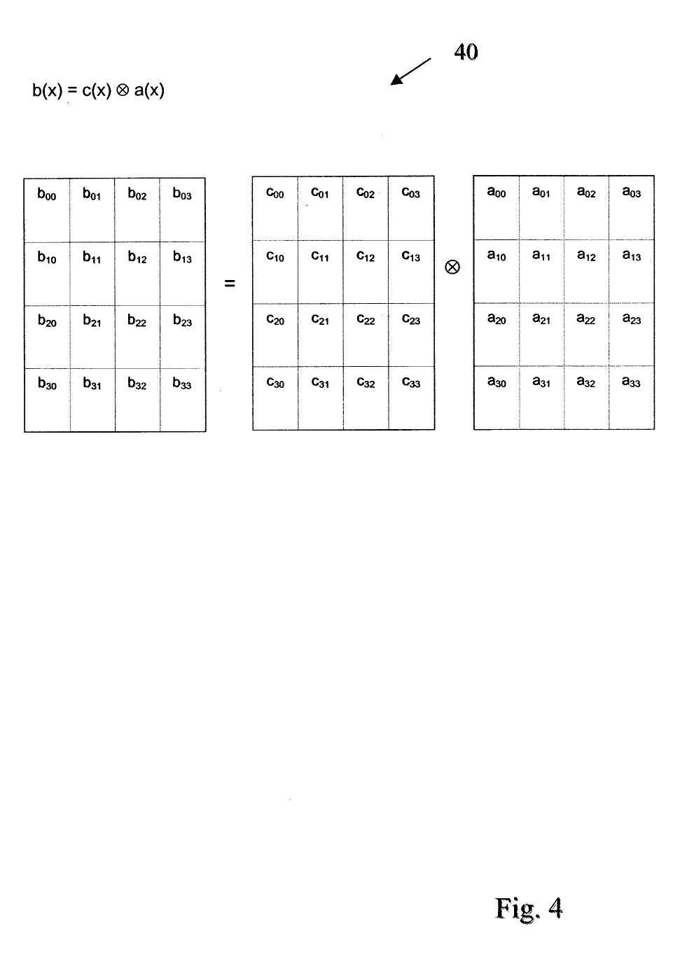

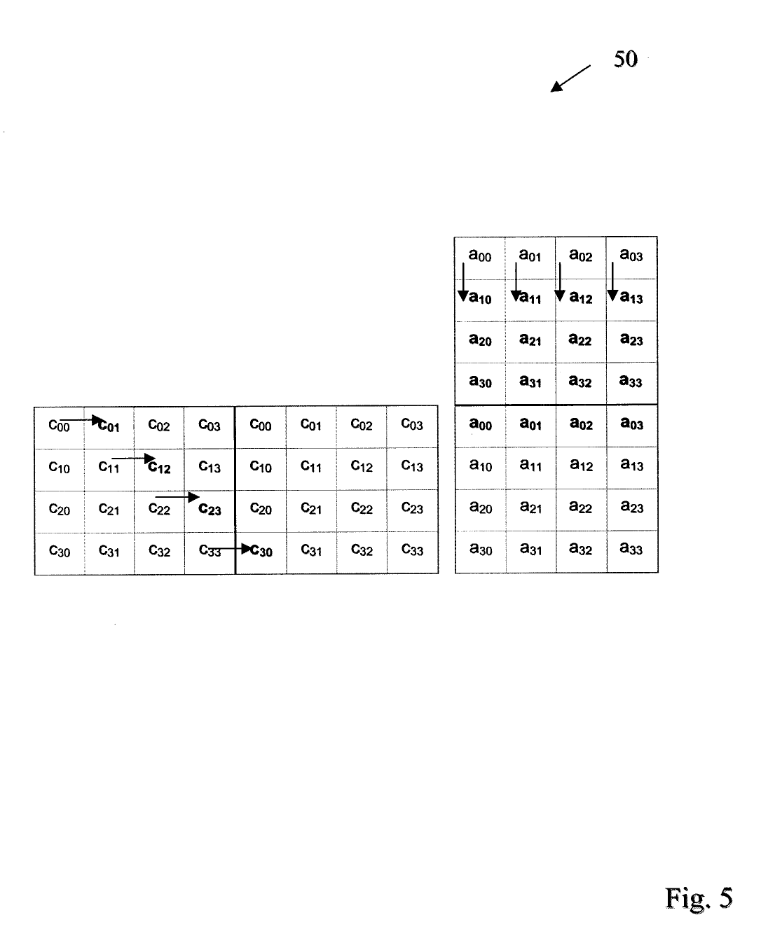

FIG. 4 shows modular multiplication 40 in accordance with the procedure generally discussed with respect to FIG. 3. In this example, the modular multiplication is a Galois field arithmetic where XOR is used to add values without carries (e.g. binary addition without carries such that 1+1=0, 0+0=0, 0+1=1 and 1+0=1, and with results ordinarily being calculated by an XOR). As seen in FIG. 4, multiplication 40 of regular square matrices b(x)=c(x)\mathring{x}a(x) is determined. FIG. 5 illustrates determination of a register data loading pattern 50 for multiplication of the matrices illustrated in FIG. 4. As seen in an register ordering schematic 50 of FIG. 5, data in registers for the next step are in bold type. Solid lines indicate boundaries where the matrix is duplicated. In a first step columns of a are multiplied by a diagonal of c. The second step, columns of a are shifted and multiplied by the next diagonal of c as indicated by the arrows.

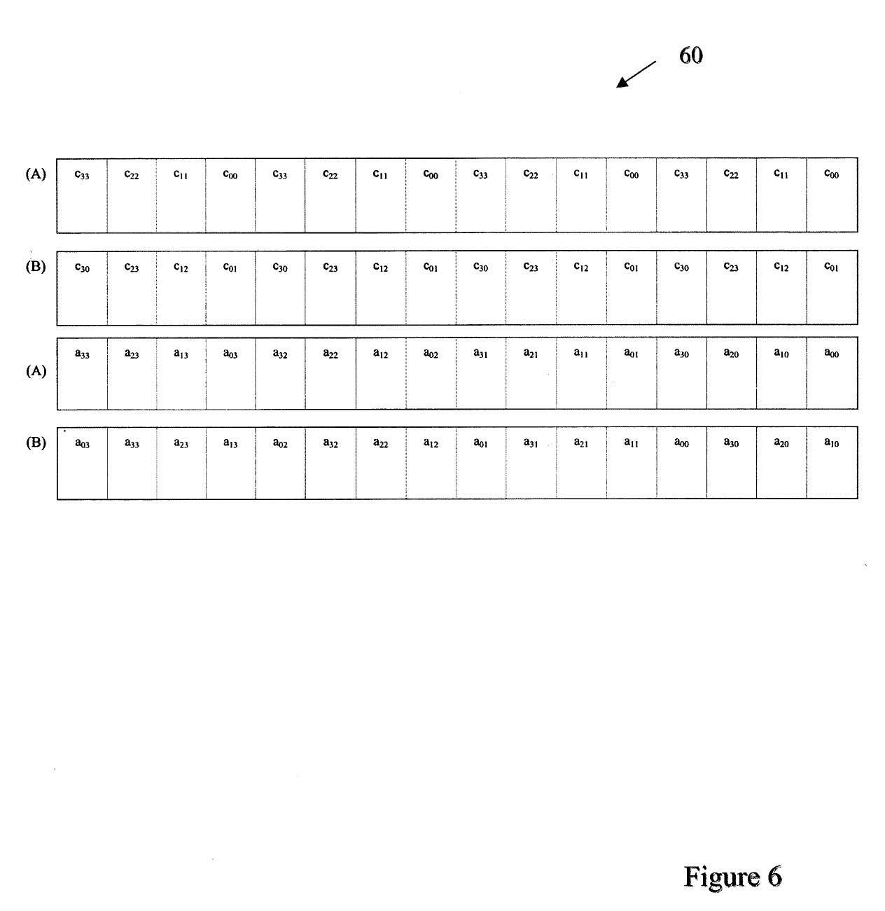

FIG. 6 illustrates the order 60 of data in registers resulting from the shifts indicated in FIG. 5. As seen with respect to timestep (A) in FIG. 6, the registers hold the main diagonal of c, and data of the a matrix in the order it is stored in memory. In timestep (B) of FIG. 6 the registers hold the diagonal and columns of a shifted. Shifting columns is implemented by rotating elements using a byte shuffle operation. Note that columns in a can be shifted up and selection diagonals in c can be selected to the left instead of the right.

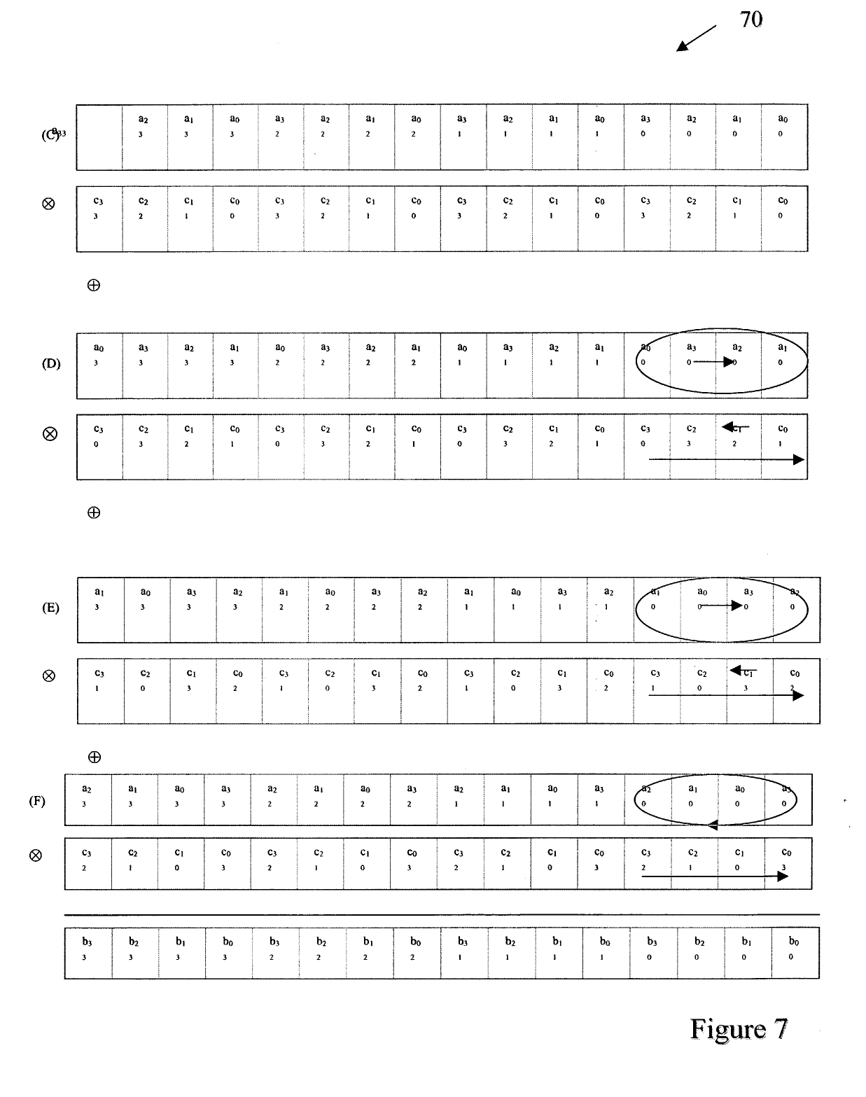

FIG. 7 further illustrates operations 70 for multiplying 4×4 matrices a and c. Data for each timestep are ordered as described above in relation to FIGS. 4 and 5. At each timestep C, D, E, and F the modular product of a and c are computed. Products are added with XOR to products of other steps.

The following psuedocode snippet provides a sample implementation of matrix multiplication for a 128 bit Rijndael round. As will be understood, the pseudo code and the MixColumn coefficient matrix with two diagonals consisting of ones (1's) are only for encryption—the forward cipher. The decryption MixColumn matrix used for decryption, the inverse cipher, does not have columns that are all ones. The code for a round of decryption is similar to the code for encryption except 4 multiply operations, one for each column, is necessary instead of two in the case of encryption.

;Third operand, i8, of MODMUL is modulus.

| | | |
|---|---|---|
| (1) | LOAD R4, MEMORY | ;ShiftRow shuffle pattern |
| (2) | LOAD R5, MEMORY | ;coefficient diagonal 1 (2s) |
| (3) | LOAD R6, MEMORY | ;coefficient diagonal 2 (3s) |
| (4) | LOAD R7, MEMORY | ;data shuffle pattern |
| (5) | LOAD R0, MEMORY | ;load data from memory (first |

pattern)

| (6) | BEGIN_LOOP | |
|---|---|---|
| (7) | S-BOX R0, R0 | ;ByteSub multiple data lookup |
| (8) | SHUFFLE R0, R4 | ;ShiftRow |
| (9) | MOVE R1, R0 | ;MixColumn copy data |
| (10) | MODMUL R0, R5,i8 | ;MixColumn multiply data by |

diagonal 1 (2s)

| | | |
|---|---|---|
| (11) | SHUFFLE R1, R7 | ;MixColumn produce second data pattern |

| | | |
|---|---|---|
| (12) | MOVE R2, R1 | ;MixColumn copy second data |

pattern

| | | |
|---|---|---|
| (13) | MODMUL R1, R6,i8 | ;MixColumn mult. 2nd data |

pattern by diag. 2 (3s)

| | | |
|---|---|---|
| (14) | XOR R0, R1 | ;MixColumn add second pattern to first |
| (15) | SHUFFLE R2, R7 | ;MixColumn produce third data pattern |
| (16) | XOR R0, R2 | ;MixColumn add third pattern |
| (17) | SHUFFLE R2, R7 | ;MixColumn produce fourth data pattern |
| (18) | XOR R0, R2 | ;MixColumn add fourth pattern |
| (19) | XOR R0, MEMORY | ;AddKey with data stored in memory |

| | |
|---|---|
| (20) | if more data return to BEGIN_LOOP |

The MixColumn operation is in bold type. MixColumn is 10 of the 13 instructions in a round. There ate only 2 multiply instructions since all values of 2 of the diagonals of the multiplicand matrix, c, are equal to 1. Consequently, no multiplication is necessary for these diagonals. Note that the same rotation pattern is used for each shuffle so the shuffle pattern can be stored in a register.

S-BOX, SHUFFLE, and MODMUL operations in the pseudocode are understood to behave as follows:

S-BOX OP1, OP2

The S-BOX operation is a multiple table lookup instruction. The S-BOX table contains the 256-byte values for the S-BOX of the Rijndael cipher. Each byte in the SIMD OP2 operand, which may be a SIMD register or memory, is used as an index that accesses a byte entry in the table. Each byte accessed in the table by the S-BOX operation is written into the OP1 register. The number of bytes that can be accessed with a single instruction is the number of bytes that can be held in a SIMD register. Therefore, a 128-bit register can access a full 128-bit block. A different table and therefore a different S-BOX instruction are used for decryption.

MODMUL OP1, OP2, OP3 are instructions that use a Galois field with 8-bit elements to multiply bytes in OP1 by bytes in OP2. The products which are bytes are written into OP1. OP1 is generally a SIMD register and OP2 is a SIMD register or memory. OP3 is the modulus and may be a register or an immediate. Although Galois field multiplication bytes has a 9-bit modulus, it can be described in 8 bits because the MSB is always 1. In the foregoing pseudocode, the modmul instruction has three operands, including the modulus of the modular multiply instruction. The modulus is 1 bit longer than the data type so a modulus for a byte is 9 bits. Rijndael specifies a 9-bit modulus whose hexadecimal value is 11B. The MSB of the modulus is always 1 so the modulus for byte modular multiplication can be described defined with a byte. Consequently, the MODMUL instruction in the pseudo code has a byte immediate as the third operand. This operand is the modulus. In the case of Rijndael the value of the immediate in hexadecimal notation is 1B.

SHUFFLE OP1,OP2 is a shuffle operation. The data in OP2 provide a pattern for shuffling data in OP1.

For decryption, the foregoing pseudocode can be slightly modified by replacing instructions (16) through (19) above as follows:

| | |
|---|---|
| 16) MOVE R3, R2 | ;copy R2 results |

17) MODMUL R2, MEMORY_p3; multiply third pattern result by
third diagonal stored at
MEMORY_p3

| | |
|---|---|
| 18) XOR R0, R2 | ;Add result in R2 to sum in R0 |

19) SHUFFLE R3, R7 ;Produce 4^{th} data pattern

| | |
|---|---|
| 20) | MODMUL R3, MEMORY_p4 ; multiply fourth pattern |

result by fourth diagonal
stored at MEMORY_p4

| | | |
|---|---|---|
| 21) | XOR R0, R3 | ;add 4^{th} pattern results |

| | |
|---|---|
| 22) | XOR R0, MEMORY_r_key ;add round key |

Alternatively, the following pseudocode snippet provides a sample implementation of matrix multiplication for a 256 bit Rijndael round:

| (1) | LOAD R4, MEMORY | ;ShiftRow shuffle pattern |
|---|---|---|
| (2) | LOAD R5, MEMORY | ;coefficient diagonal 1 (2s) |
| (3) | LOAD R6, MEMORY | ;coefficient diagonal 2 (3s) |
| (4) | LOAD R7, MEMORY | ;data shuffle pattern |
| (5) | LOAD R0, MEMORY | ;load data from memory |
| | | (first pattern) |
| (5) | LOAD R1, MEMORY | ;load data from memory |
| | | (first pattern) |
| (6) | BEGIN_LOOP | |
| (7) | S-BOX R0, R0 | ;S-Box multiple data |

lookup low 4

cols

| | | |
|---|---|---|
| (8) | S-BOX R1, R1 | ;S-Box multiple data |

lookup high 4

cols

| | | |
|---|---|---|
| (9) | SHUFFLE R0, R4 | ;ShiftRow bytes to transfer |

to R1 in upper part

| | | |
|---|---|---|
| (10) | SHUFFLE R1, MEMORY | ;ShiftRow bytes to transfer |

to R0 in

upper part

| | | |
|---|---|---|
| (11) | MOVE R2, R0 | ;ShiftRow copy R0 |

| | | |
|---|---|---|
| (12) | RMERGE R0, R1, N | ;ShiftRow merge N bytes R1 |

into R0

| | | |
|---|---|---|
| (13) | SHUFFLE R0, MEMORY | ;ShiftRow cols 1-4 pattern |

| | | |
|---|---|---|
| (16) | RMERGE R1, R2, N | ;ShiftRow merge N bytes R2 |

into R1

| | | |
|---|---|---|
| (17) | SHUFFLE R1, MEMORY | ;ShiftRow cols 5-8 pattern |
| (18) | MOVE R2, R0 | ;MixColumn copy data |

cols 1-4

| (19) | MODMUL R0, R5,i8 | ;MixColumn multiply data by |
|---|---|---|
| | | diagonal 1 (2s) |
| (20) | SHUFFLE R2, R7 | ;MixColumn produce second data |
| | | pattern |
| (21) | MOVE R3, R2 | ;MixColumn copy second data |
| | | pattern |
| (22) | MODMUL R2, R6,i8 | ;MixColumn mult. 2nd data |

pattern by

diag2 (3s)

| (23) | XOR R0, R2 | ;MixColumn add second pattern |
|---|---|---|
| | | to first |
| (24) | SHUFFLE R3, R7 | ;MixColumn produce third data |
| | | pattern |
| (25) | XOR R0, R3 | ;MixColumn add third pattern |
| (26) | SHUFFLE R3, R7 | ;MixColumn produce fourth |
| | | data pattern |
| (27) | XOR R0, R3 | ;MixColumn add fourth pattern |
| | | done cols 1-4 |
| (28) | MOVE R2, R1 | ;MixColumn copv data cols 5-8 |
| (29) | MODMUL R1, R5,i8 | ;MixColumn multiply data by |
| | | diagonal 1 (2s) |
| (30) | SHUFFLE R2, R7 | ;MixColumn produce second |
| | | data pattern |
| (31) | MOVE R3, R2 | ;MixColumn copy second data |
| | | pattern |
| (32) | MODMUL R2, R6,i8 | ;MixColumn mult. 2nd |

data pattern by diag.2

(3s)

| (33) | XOR R1, R2 | ;MixColumn add second pattern |
|---|---|---|
| | | to first |
| (34) | SHUFFLE R3, R7 | ;MixColumn produce third |
| | | data pattern |
| (35) | XOR R1, R3 | ;MixColumn add third pattern |
| (36) | SHUFFLE R3, R7 | ;MixColumn produce fourth |
| | | data pattern |
| (37) | XOR R1, R3 | ;MixColumn add fourth pattern |
| (38) | XOR R0, MEMORY | ;AddKey with data stored |
| | | in memory |
| (39) | XOR R1, MEMORY | ;AddKey with data stored |

in memory

| | |
|---|---|
| (40) | if more data return to BEGIN_LOOP |

The MixColumn operation is in bold type. MixColumn is 20 of the instructions doubling the number of instructions as compared to the foregoing 128 bit implementation. As will be appreciated, a block must be stored in 2 registers (or operand memory locations). This doubles the total number of multiply operations, but there are still only to multiply operations on each of the sections of the block.

While this invention is particularly useful for multiplication of encryption/decryption matrices of byte data implemented with SIMD instructions the invention is not restricted to such multiplications. Larger data types can be used, only requiring reduction in the number of elements that can be stored in a register, and larger matrices have more elements that must be stored. If diagonals of the multiplicand matrix, c, or the columns of the multiplier matrix, a, do not fit in a SIMD register they can be extended to additional registers. In some cases for using larger registers the rotation of data in a column may require exchanging elements between registers. In addition, alternative block ciphers can be used, including but not limited to, procedures such as Twofish or FEC.

As will be understood, reference in this specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Accordingly, it is the following claims, including any amendments thereto, that define the scope of the invention.

The claimed invention is:

1. An encryption method, comprising:
enciphering a plaintext using block cipher with at least one key, further comprising division of a plaintext into blocks, with each block having multiple encryption rounds applied, with each round including performance of a matrix multiplication by loading each diagonal of a multiplicand matrix into a processor accessible memory,
loading a multiplier matrix into at least one processor accessible memory in column order and shifting elements in each column in the processor accessible memory by at least one element, and
multiplying diagonals of the multiplicand matrix by columns of the multiplier matrix, with their product being added to the sum of products for columns of a result matrix.

2. The method according to claim 1, wherein the processor accessible memory is a SIMD register.

3. The method according to claim 1, wherein the modular arithmetic having no carry addition is used during matrix multiplication.

4. The method according to claim 1, wherein the multiplier matrix represents multiplication by a polynomial to reduce correlation between data of each round input and data of each round output.

5. The method according to claim 1, wherein the Rijndael algorithm is used.

6. A decryption method, comprising:
deciphering a encrypted block using block cipher and a received key, with each encrypted block having multiple decryption rounds applied, with each round including performance of a matrix multiplication by loading each diagonal of a multiplicand matrix into a processor accessible memory,
loading a multiplier matrix into at least one register in column order and shifting elements in each column in the processor accessible memory by one element, and
multiplying diagonals of the multiplicand matrix by columns of the multiplier matrix, with their product being added to the sum of products for columns of a result matrix.

7. The method according to claim 6, wherein the processor accessible memory is a SIMD register.

8. The method according to claim 6, wherein the modular arithmetic having no carry addition is used during matrix multiplication.

9. The method according to claim 6, wherein the multiplier matrix represents multiplication by a polynomial to reduce correlation between data of each round input and data of each round output.

10. The method according to claim 6, wherein the Rijndael algorithm is used.

11. An article comprising a storage medium having stored thereon instructions that when executed by a machine result in:
enciphering a plaintext using block cipher with at least one key, further comprising division of a plaintext into blocks, with each block having multiple encryption rounds applied, with each round including performance of a matrix multiplication by loading each diagonal of a multiplicand matrix into a processor accessible memory,
loading a multiplier matrix into at least one register in column order and shifting elements in each column in the processor accessible memory by at least one element, and
multiplying diagonals of the multiplicand matrix by columns of the multiplier matrix, with their product being added to the sum of products for columns of a result matrix.

12. The article comprising a storage medium having stored thereon instructions of claim 11, wherein the processor accessible memory is a SIMD register.

13. The article comprising a storage medium having stored thereon instructions of claim 11, wherein the modular arithmetic having no carry addition is used during matrix multiplication.

14. The article comprising a storage medium having stored thereon instructions of claim 11, wherein the multiplier matrix represents multiplication by a polynomial to reduce correlation between data of each round input and data of each round output.

15. The article comprising a storage medium having stored thereon instructions of claim 11, wherein Rijndael algorithm is used.

16. An article comprising a storage medium having stored thereon instructions that when executed by a machine result in:
deciphering a encrypted block using block cipher and a received key, with each encrypted block having multiple decryption rounds applied, with each round including performance of a matrix multiplication by loading each diagonal of a multiplicand matrix into a processor accessible memory,
loading a multiplier matrix into at least one register in column order and shifting elements in each column in the processor accessible memory by one element, and
multiplying diagonals of the multiplicand matrix by columns of the multiplier matrix, with their product being added to the sum of products for columns of a result matrix.

17. The article comprising a storage medium having stored thereon instructions of claim 16, wherein the processor accessible memory is a SIMD register.

18. The article comprising a storage medium having stored thereon instructions of claim 16, wherein the modular arithmetic having no carry addition is used during matrix multiplication.

19. The article comprising a storage medium having stored thereon instructions of claim 16, wherein the multiplier matrix represents multiplication by a polynomial to reduce correlation between data of each round input and data of each round output.

20. The article comprising a storage medium having stored thereon instructions of claim 16, wherein the Rijndael algorithm is used.

21. An encryption system comprising
a memory unit containing plaintext data,
a processor connected to the memory unit to load plaintext data from the memory unit to perform data encryption, with data encryption including matrix multiplication by loading each diagonal of a multiplicand matrix into a processor accessible memory, with a multiplier matrix loaded into at least one processor accessible memory in column order, and
control logic to shift the multiplication and addition elements in each column of the multiplier matrix in the registers by shifting one element, and multiply diagonals of the multiplicand matrix by columns of the multiplier matrix, with their product being added to the sum of products for columns of a result matrix.

22. The system according to claim 21, wherein the processor accessible memory is a SIMD register.

23. The system according to claim 21, wherein the modular arithmetic having no carry addition is used during matrix multiplication.

24. The system according to claim 21, wherein the multiplier matrix represents multiplication by a polynomial to reduce correlation between data of each round input and data of each round output.

25. The system according to claim 21, wherein Rijndael algorithm is used.

26. An decryption system comprising
a memory unit containing encrypted data,
a processor connected to the memory unit to load encrypted data from the memory unit to perform data decryption, with data encryption to plaintext including matrix multiplication by loading each diagonal of a multiplicand matrix into a processor accessible memory, with a multiplier matrix loaded into at least one processor accessible memory in column order, and control logic to shift multiplication and addition elements in each column of the multiplier matrix in the registers by shifting one element, and multiply diagonals of the multiplicand matrix by columns of the multiplier matrix, with their product being added to the sum of products for columns of a result matrix.

27. The system according to claim 26, wherein the processor accessible memory is a SIMD register.

28. The system according to claim 26, wherein the modular arithmetic having no carry addition is used during matrix multiplication.

29. The system according to claim 26, wherein the multiplier matrix represents multiplication by a polynomial to reduce correlation between data of each round input and data of each round output.

30. The system according to claim 26, wherein the Rijndael algorithm is used.
